(19) United States
(12) Patent Application Publication
(10) Pub. No.: US 2008/0248710 A1
(43) Pub. Date: Oct. 9, 2008

(54) Two-Dimensional Web Material, Method and Apparatus for Manufacturing the Same as Well as Use Thereof

(76) Inventor: Manfred Wittner, Mannheim (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/909,329

(22) PCT Filed: Mar. 15, 2006
(86) PCT No.: PCT/EP2006/002345

§ 371 Date: Jun. 11, 2008

(30) Foreign Application Priority Data
Mar. 21, 2005 (DE) 10 2005 012 906.4

(51) Int. Cl. D04H 1/40; B32B 37/00; B32B 38/06; B29C 59/04

(52) U.S. Cl. 442/328; 156/60; 156/308.4; 156/535; 156/209

(57) ABSTRACT

The invention relates to a two-dimensional web material made of a layer material and also a method and an apparatus for manufacturing the same, wherein the two-dimensional web material contains a non-woven material and has a Poisson's ratio of <0.2 during expansion in the machine direction.

The invention relates to a two-dimensional web material made of a layer material, as well as a method and an apparatus for manufacturing the web material and the use thereof.

Two-dimensional polymer-based web materials using non-woven materials are known. Depending on the purpose of use they are produced as single-layer or multi-layer products in various manufacturing methods and are compressed and/or consolidated and/or bound in discrete regions for obtaining defined usage properties and can comprise various bonding patterns.

When further processing or using these web materials, a tensile loading is applied on the web material in the processing direction, i.e. in the x-direction during the winding and unwinding processes, wherein said tensile loading can result in an expansion of the web in the x-direction and a partly enormous negative length variation in the form of a transversal contraction of the web transverse to the loading direction, i.e. in the y-direction.

The ratio of the transversal contraction to the longitudinal dilatation is also known as Poisson's ratio ν with

ν=−(Δd/d)/(Δl/l)=−(Δy/y)/(Δx/x)

For solids, Poisson's ratios in the range of 0.2 to 0.5 are known. Non-woven materials exhibit a special feature due to their fiber structure in comparison with compact solids. If a tensile force is applied on a non-woven material, then the fibers randomly distributed in the non-woven material are aligned in the tensile direction, due to which a consolidated negative length variation in the y-direction can occur.

Conventional non-woven materials can have Poisson's ratios of >0.5.

This negative length variation in the form of a constriction of the web can bring about
a reduction of the use of the width of the web,
a change in the material properties due to the structural displacement in the y-direction, i.e. transverse or perpendicular to the machine direction, together with an increase in the base weight or increase in width or
wrinkling
   during the further processing or use of the web, all of which necessitate expensive measures for guiding the web, for example, by installing additional rollers and scroll roll units.

Furthermore, polymer-based products having microporous structures are known, in which defined regions of the polymer are removed by means of laser processes, so that the products thus manufactured neither get constricted during a longitudinal expansion in the x-direction, nor do they exhibit an increase in length in the y- or z-direction, that is, transverse or perpendicular to the expansion direction. Should these materials exhibit an increase in length in the y-direction and/or z-direction, that is, should they have negative Poisson's ratios, they are also referred to as auxetic materials. For example, foam materials and non-porous web materials having auxetic behavior are known, said foam materials and web materials being used in industrial areas as absorbers, filter media, sound insulators and packaging materials.

Thus a filter method using a porous barrier material made of a polyurethane co-ester or silicon is known, for example, from WO99/22838. The porosity of the barrier material is created by means of a laser process, wherein pores and ligaments are formed, which result in a single-layer or multi-layer figure and are effective as a two-dimensional or three-dimensional barrier in the filter medium. Preferably pore sizes of between 1 μm and 5 cm are created. A Poisson's ratio of <0.1 was determined on this material.

Furthermore, a material composition having a negative Poisson's ration of 0.7 is known from EP0328518/U.S. Pat. No. 4,668,557, wherein an open cell foam structure is created, which comprises interconnected ribs. Subsequently, a force is applied on the foam structure in such a way that the material is compressed simultaneously in three directions, which are orthogonal in relation to one another, and the ribs of the cells are thereby buckled inwards. In this state the material is heated to a temperature which slightly exceeds the softening temperature of the material and is relieved of loading only after cooling it to a temperature below the softening temperature, wherein the inwardly buckled ribs return to their original state. The material can be used, for example, in filter technology, for sound insulation or in medical technology, e.g. for stabilizing blood vessels.

In WO04/012785 a tubular liner for medical applications in the field of blood vessels is disclosed, said tubular liner being manufactured out of an auxetic material, wherein the liner consists of a plurality of adjacent radial loops, each radial loop comprising a plurality of interconnected inverted hexagons and the hexagons are interconnected by means of strips. An excimer laser process is used to create these hexagons.

Biodegradable polymers, for example, caprolactone are described as the polymers used.

Likewise materials consisting of fibrils or nodes clinging to one another by extrusion and adhesion and forming structures having auxetic behavior are known.

WO00/53830 describes an auxetic polymer material in filamentary or fibrous form and discloses a method for forming the material. Here, a thermo formable particulate polymeric material, in which the particles are not completely melted, is extruded and joined during the spinning process. The resulting auxetic microstructure consists of fibrils and nodes, wherein the nodes have irregular structures and diameters of up to 300 μm. The material can be used for manufacturing protective clothing and bandages. Together with non-auxetic material, it can be used in the field of filter technology.

From WO91/01210 a polymeric material having a microstructure made of fibrils and nodes is known as well, which is produced in a first process step by extrusion and compression of the particulate polymer. Downstream of the extrusion process is a drawing process, in which the material is subjected to tensile stress and shear stress at >100° C. and a pressure of between 1 and 100 Mpa perpendicular to the draw direction of the material. The auxetic microstructure exhibits Poisson's ratios of −0.25 to −12. Copolymers and homo-polymers, polymeric materials containing fillers and also high molecular polyethylene containing fillers are used as polymers, wherein a density of 150 kg/m3 is disclosed. Such materials can be used as components of sandwich panels and also for shock and vibration absorption and in medical applications.

Furthermore, a paper substrate having auxetic behavior and which is expandable in x and y directions is described in WO02/36084. The paper substrate having the first thickness also has a second thickness after a stress in the form of a plastic expansion, wherein the ratio of the second thickness to the first thickness is >4 and is referred to as the thickness index. The paper substrate consists of at least two connected layers in a face-to-face arrangement, wherein the plastic expansion in the x direction or in the y direction brings about a stronger length variation in the z direction. The paper substrate is manufactured by applying a cellulose fiber slurry on a filter band and subsequent drying, wherein perforations are inserted in the paper substrate in the z direction in a defined arrangement using a set of rollers having a rotary knife and subsequently a stretch of the paper substrate in the xy direction takes place. Areas of application for this paper substrate include the fields related to sanitary towels, diapers and wipes.

It is intended to provide a two-dimensional polymer-based web material using fibrous materials, said web material being designed in such a way that it results in only a minimum negative length variation during tensile loading in the x direction or even a positive length variation in the y direction.

The present invention sets in at this point.

It is the object of the present invention to expand the area of application and technology of materials having very small or even negative Poisson's ratios.

This object is achieved by a two-dimensional web material made of a layer material having the characteristics of claim 1.

Additional preferred embodiments, processes, apparatuses and applications are specified in the subsequent claims.

The present invention provides a two-dimensional web material made of a layer material, wherein the two-dimensional web material contains a non-woven material and first and second discrete regions, which are arranged relative to one another in such a way that they form a pattern in the form of inverted polygons and that the two-dimensional web material has a Poisson's ratio of <0.2 during expansion in the machine direction. The two-dimensional web material preferably has Poisson's ratios of between <0.2 and −2.

In an improved configuration of the invention, the two-dimensional web material is compressed and/or consolidated and/or bound in first discrete regions in such a way that the first discrete regions are embodied in the form of ligaments, which form the sides of the edges of inverted polygons and that the two-dimensional web material has a Poisson's ratio of <0.2 during expansion in the machine direction.

The words “inverted polygons” are used here in order to describe two-dimensional polygonal figures, which have inward-looking angles.

The expression “compressed” is used here in order to describe a state inside a layer material, in which a non-woven material or a fibrous material is compressed strongly in general.

The expression “consolidated” is used here, if the non-woven material or the fibrous material is strongly compressed and additionally partially molten and exhibits isolated bonding joints.

The word “bound” refers to layer materials in which the non-woven material or the fibrous components in the discrete regions are molten almost completely or completely and the individual layers of the layer material in these discrete regions cling to one another.

The words “first discrete regions” are used here in order to describe regions in the or on the web material or in the layer material, said first discrete regions forming the edges of the inverted polygons or hexagons or triangles.

The words “second discrete regions” are used here in order to describe regions in the or on the web material or the layer material, said regions being located inside the edges of the inverted polygons or hexagons or triangles. According to another embodiment, the two-dimensional web material in the first discrete regions comprises ligaments, which form the sides of the edges of inverted polygons. The sides have an aspect ratio of their length to their width of between >2 and <20, preferably between 4 and 10 and are arranged at an angle of between 0° and 180° relative to one another, so that the two-dimensional web material has a Poisson's ratio of <0.2 during expansion in the machine direction.

In an improved configuration of the invention, the two-dimensional web material comprises second discrete regions, which are uncompressed and are embodied as inverted polygons and the two-dimensional web material has a Poisson's ratio of <0.2 during expansion in the machine direction.

In another embodiment, the two-dimensional web material comprises second discrete regions, which are perforated and are embodied as inverted polygons.

In additional embodiments, the two-dimensional web material comprises polygons in the form of inverted hexagons, which are formed out of isosceles or non-isosceles triangles. The first discrete regions comprise ligaments, which form the sides of the edges of inverted polygons, wherein the sides have an aspect ratio of their length to their width of between >2 and <20, preferably between 4 and 10 and are arranged at an angle of between >0° and <90° relative to one another.

In another embodiment, the two-dimensional web material comprises second discrete regions, which are uncompressed and are formed out of isosceles triangles, which are arranged in such a way relative to one another that they are interconnected in pairs in the region of their acute angles and form inverted hexagons.

According to a design form of the invention, the two-dimensional web material comprises in second discrete regions perforations, which are formed out of isosceles triangles, which are arranged in such a way relative to one another that they are interconnected in pairs in the region of their acute angles and form inverted hexagons.

The advantage of this solution is that the two-dimensional web material firstly has properties, which are known from non-woven materials, fibrous materials in general or films, either alone or in combinations among themselves. Secondly, this web material comprises first and second discrete regions, which bring about length variations in the y direction during tensile loading in the x direction—a property that hitherto known two-dimensional webs using synthetic fibers do not exhibit. The inverted polygons, which are embodied by the design of the first and/or second regions in the web material, can thereby be designed to be of uniform or varying size.

The extent of the expansion and transversal contraction of the two-dimensional web material is adjustable during tensile loading by
the shape of the ligament sides, i.e. the side length, side width and side height,
the arrangement of the sides, i.e. their direction and angle relative to one another and
the proportion of bound and/or consolidated and/or compressed and/or perforated regions in the two-dimensional web.

This combination of properties imparts the two-dimensional web material according to the invention several advantages with respect to its handling in comparison with the hitherto known web materials. For example, in this material the so-called “Neck down effect” occurring in conventional web materials during the winding process, the deformation, styling or application, can be observed only to a reduced extent or not observed at all.

Due to the associated constancy of height or base weight of the web material over its entire width, a product is provided using the web material according to the invention, said product comprising an increased property constancy over its entire width and requiring no expensive measures for guiding the fabric during the manufacturing and application process.

For manufacturing the two-dimensional web material out of a layer material, a process is provided, wherein the two-dimensional web material contains a non-woven material, and first and second discrete regions are arranged in such a way relative to one another that they form a pattern in the form of inverted polygons and that the two-dimensional web material has a Poisson's ratio of <0.2 during expansion in the machine direction.

In another embodiment of the process for manufacturing a two-dimensional web material out of a layer material, first and second regions are arranged in the two-dimensional web material relative to one another in such a way that they form a pattern in the form of inverted hexagons and that the two-dimensional layer material has a Poisson's ratio of <0.2 during expansion in the machine direction.

The following can be used for manufacturing the web material:
consolidated, partly consolidated and unconsolidated layer materials,
expandable, elastic and inelastic layer materials,
films,
Non-woven materials such as, e.g. melt-blown non-woven materials and spunlaid fabric, which are produced in a melt-spinning process, electro-spinning process or solution spinning process, or carded non-woven materials, wetlaids, airlaids and
Laminates made of films and/or non-woven materials.

According to a design form, for example, a multi-layer web material is produced by providing a layer material. This layer material can be, for example, a product made of one or more layers of a non-woven material, produced by means of a spun-bonding equipment having one or more beams, wherein the non-woven materials can be unconsolidated or pre-consolidated or only compressed. Subsequently, the layer material is compressed and/or consolidated and/or bound in discrete regions and the first discrete regions are arranged relative to one another in such a way that they form a pattern in the form of inverted polygons. The patterns can thereby be embodied as ligaments, wherein these ligaments are arranged in such a way that they form the edges of the inverted polygons.

Furthermore, a second layer can be applied on a prefabricated material, embodied as a non-woven material or a film or a combination thereof and after that the embodiment of the ligaments can take place. It is also possible to manufacture the first and second layers in line and to carry out the embodiment of the ligaments in a separate processing step. Likewise, combinations of films and non-woven materials can be manufactured, in that, for example, a film is extruded onto a carded non-woven material and subsequently the embodiment of the ligaments takes place.

Alternatively, layer materials can also be provided in the form of films, non-woven materials or laminates, wherein these are subsequently brought into contact with, for example, a non-woven material, film or laminate by adhesion, and the embodiment of the ligaments takes place in or on the layer material in another processing step, said ligaments being arranged in such a way that they form inverted polygons.

In another improved configuration of the process, the two-dimensional layer material is provided and perforated in second discrete regions, which are arranged relative to one another in such a way that they form a pattern in the form of inverted polygons.

The perforations can also be embodied as inverted hexagons, in that isosceles or non-isosceles triangles are arranged in combinations of one another in such a way that they form inverted hexagons and that the two-dimensional web material thus produced has a Poisson's ratio of <0.2 during expansion in the machine direction.

For example, the web material can be embodied after the perforation process as a net having uniformly or variably large perforations. In addition, the perforations in another configuration of the invention can be expanded by tensile loading.

Furthermore according to an improved configuration of the process, the layer material is provided and a hot melt adhesive is applied on first discrete regions of the surface of the layer material in such way that a pattern in the form of ligaments forming the sides of the edges of inverted polygons is embodied in the first discrete regions after the hot melt adhesive hardens.

In improved configurations of the process, the first discrete regions in the two-dimensional web material are provided by means of thermobonding or even, for example, by spunlacing or airlacing or ultrasound or combinations of these processes. According to an improved configuration of the process, embossing points can be created in the second discrete regions of the layer material by means of thermobonding.

According to an additional concept of the invention, an apparatus comprising at least one embossing roller is suggested for producing a two-dimensional web material out of a layer material, wherein the embossing roller comprises oblong elevations in the form of ligaments, which are arranged relative to one another in such a way that they form the sides of the edges of inverted polygons, such that the sides exhibit an aspect ratio of their length to their width of between >2 and <20, preferably between 4 and 10 and have a height of between 0.2 mm and 2 mm and are arranged at an angle of between >0° and <180° relative to one another.

The inverted polygons can also be embodied in an improved configuration of the apparatus as inverted hexagons in such a way that the sides of the edges of inverted hexagons have an aspect ratio of their length to their width of between >2 and <20, preferably between 4 and 10, have a height of between 0.2 mm and 2 mm and are arranged at an angle of between >0° and <900 relative to one another.

The apparatus for producing a two-dimensional web material out of a layer material can thereby comprise a roller pair having an embossing roller and a smoothing roller.

Alternatively, the apparatus for producing a two-dimensional web material can comprise a roller pair, in which the roller clearance is formed by two embossing rollers having the same embossing patterns. The embossing rollers are thereby arranged and coordinated to one another with respect to their circumferential speed in such a way that the ligaments forming the embossing patterns meet precisely on top of one another and enable a point-to-point bonding.

It has proved to be advantageous to embody the oblong elevations of the embossing roller located in the boundary areas of the latter more strongly with respect to their base height than the oblong elevations located in the direct proximity of the center of the embossing roller.

The oblong elevations can be distributed evenly on the surface of the embossing roller or can be embodied only in the boundary area of the embossing roller. The oblong elevations on the embossing roller can be embodied uniformly with respect to their aspect ratio. In addition, even more strongly embodied elevations towards the lateral boundaries of the embossing roller can also prove to be advantageous.

Another concept of the invention provides an apparatus for manufacturing a two-dimensional web material out of a layer material, said apparatus containing a pivoted screening drum, wherein the screening drum comprises on its surface oblong openings, which are arranged relative to one another in such a way that they form the sides of the edges of inverted polygons such that the sides have an aspect ratio of their length to their width of between >2 and <20, preferably between 4 and 10 and are arranged at an angle of between >0° and <180° relative to one another.

According to an additional concept of the invention, an apparatus for manufacturing a two-dimensional web material is suggested, said apparatus containing a device for applying a hot melt adhesive on discrete first regions, wherein the device has boreholes and/or nozzles, which are arranged relative to one another in such a way that they form the sides of the edges of inverted polygons such that the sides have an aspect ratio of their length to their width of between >2 and <20, preferably between 4 and 10 and are arranged at an angle of between >0° und <180° relative to one another.

The two-dimensional web material can be single-layered or can consist of two or more layers. The individual layers of the laminate can be interconnected among themselves in the similar or different manner. For example, the layers can be compressed and/or consolidated and/or bonded in first discrete regions, wherein the ligaments, which are formed in the form of sides of the edges of inverted polygons or hexagons, are created by means of thermobonding or by means of adhesives or even, for example, using spunlacing or airlacing or ultrasound processes or combinations thereof.

The first discrete regions, which are formed in the form of sides of the edges of inverted polygons or hexagons and/or second discrete regions in the form of perforations can have different sizes. In particular, it has proved to be advantageous to design the first and/or second discrete regions in the boundary regions of the two-dimensional web material in its two-dimensional expansion in x and y direction to be smaller than those discrete regions, which are in direct proximity of the center of the web material.

The discrete first and second regions can be evenly distributed on the surface of the two-dimensional web material distributed or they can be embodied only in the boundary region of the web material.

Furthermore, the first and second discrete regions on the web material can be uniformly designed with respect to their aspect ratio and their two-dimensional expansion. In addition, more strongly embodied first discrete and second discrete regions toward the lateral boundaries of the web material can also prove to be advantageous.

Polymers, in the form of hot melt adhesives, can be used as preferred adhesives, wherein said hot melt adhesives are heated up and during the cooling process create a bond between the layers. The application of the adhesives preferably takes place by spraying the heated polymer on discrete first regions of the layer material or also in the form of foam application.

Web materials, which are embodied with first discrete regions of between 10% and 60% with respect to the total area of the web material, have proved to be advantageous.

For the production of the two-dimensional web material, synthetic materials, such as for example homopolymers and copolymers, preferably polyolefins can be used. The polymers can contain additives, which bring about special surface properties in the web material. Furthermore, the polymers can be equipped with fillers and reinforcements.

In addition, even combinations of synthetic and natural materials can be used.

For embodying the fibrous components of the web material in the form of fibrous materials, in general, or non-woven materials, both mono-component and also multi-component filaments manufactured according to known spinning processes are suitable. The cross sections of the filaments can thereby be round, flat, tri-lobal or multi-lobal. Likewise the filaments can have hollow spaces or be embodied as hollow fibers. The surfaces of the filaments can be smooth or jagged.

The two-dimensional web materials thus produced can exhibit very different images of characteristics. For example, the web material can be equipped to be hydrophilic, hydrophobic, antistatic, electrostatic, alcohol-resistant, or flame-resistant.

The two-dimensional web material according to invention can be used as a component in sanitary products or disposables. The latter can be diapers, sanitary napkins, incontinence products etc.

As the component of a sanitary product, for example in the form of a diaper, the two-dimensional web material can be used as a perforated top sheet. During tensile loading the pores are expanded and the liquid can rapidly arrive into the interior of the diaper, in order to be absorbed there.

These two-dimensional web materials can also be used in the field of medical products, for example as covering or protective clothing or as bandages. Further applications include the field of filter technology or the sanitary or household sector, for example as wipes. Likewise the use of the two-dimensional web material as a component of packaging material or a geotextile is possible.

For example such a material can comprise a two-dimensional web material having first and second discrete regions, said web material being brought into contact with a conventional non-woven material or film or a laminate made of one or more non-woven materials or films or combinations thereof. By the combination of these materials, a multi-layer web material is produced, which exhibits a higher rigidity compared with hitherto known web materials using non-woven materials.

Additional advantageous design forms and improved configurations are based on the following drawings, which, however are not to limit the invention in its embodiment. The characteristics and improved configurations illustrated there can also be combined with the embodiments of the invention described above and otherwise not specified in more detail. The following is illustrated:

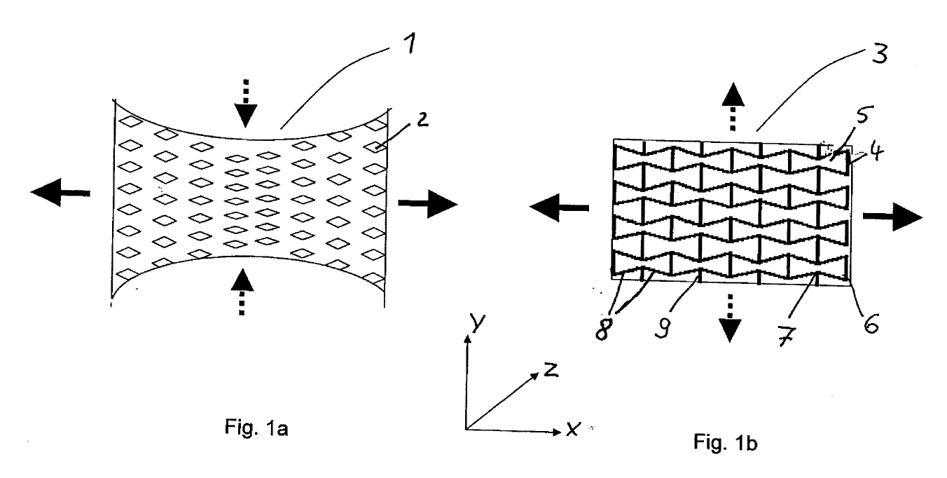

FIGS. 1a and 1b: Comparison of conventional web material and web material according to invention

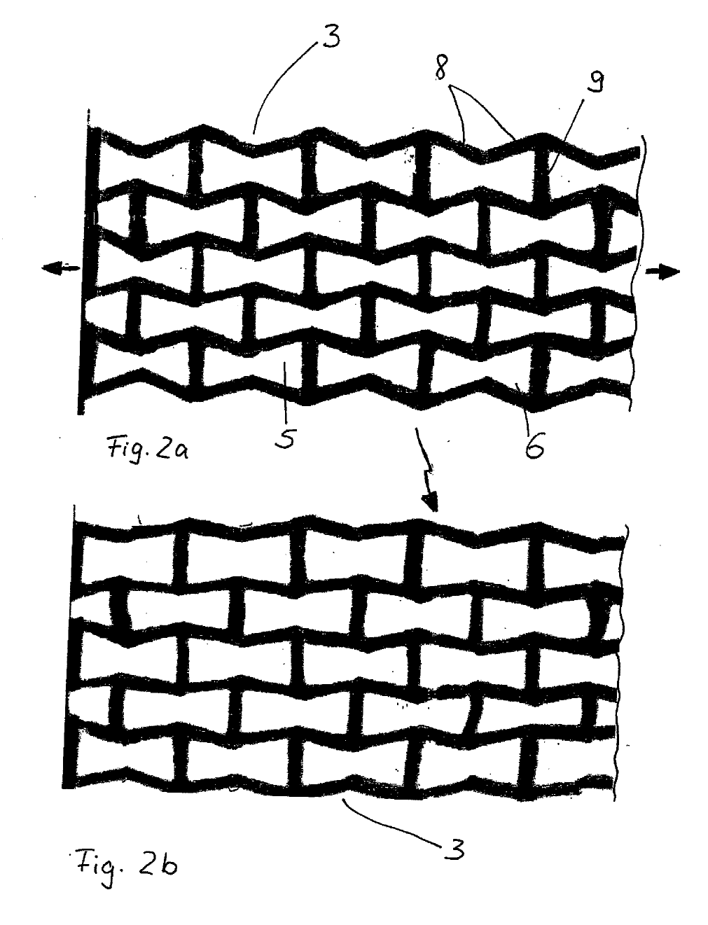

FIGS. 2a and 2b: Web material having perforations (a) before and (b) during the tensile loading

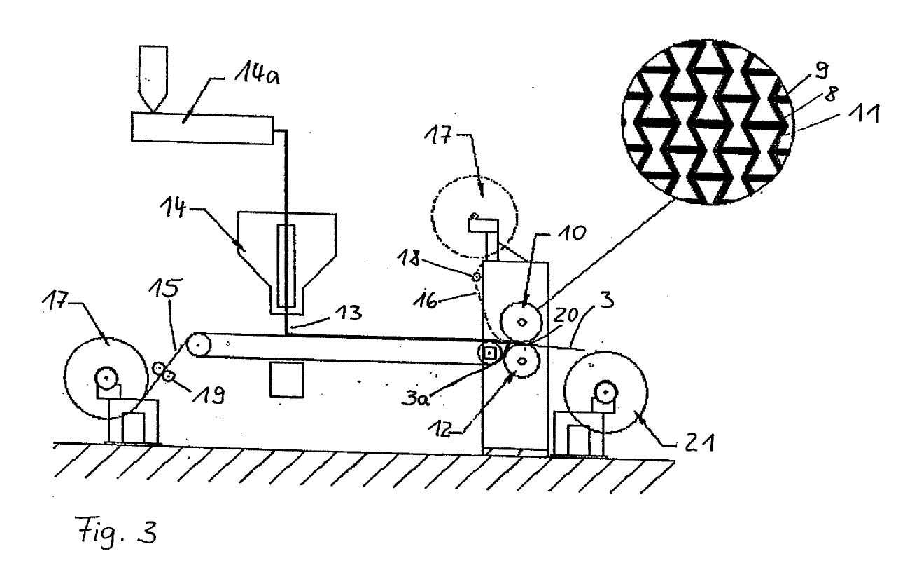

FIG. 3: Apparatus for the production of the web material with smoothing and embossing roller

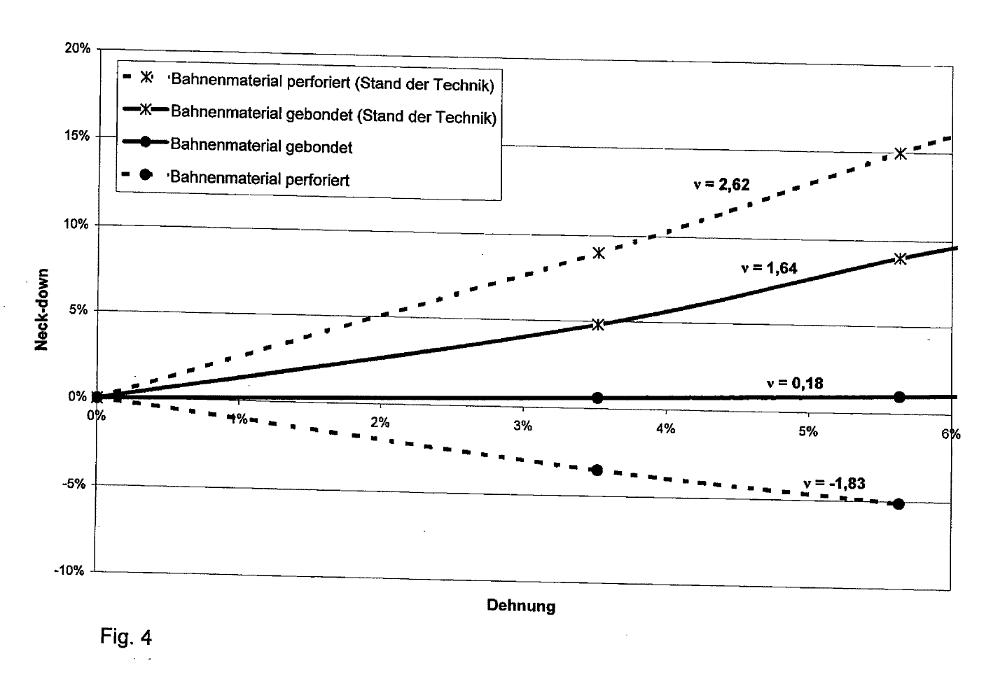

FIG. 4: Expansion and neck-down effect

FIGS. 1a and 1b schematically illustrate a web material 1 having known bonding patterns 2 and a web material 3 according to the invention having inverted polygons and first 4 and second 5 discrete regions. Inverted hexagons 6 having inward-looking corners 7 are illustrated by way of example. In comparison with the expansion perpendicular to the loading direction, the web material 1 having conventional bonding patterns 2 exhibits the typical neck-down effect in the y-direction during an expansion in the x-direction. In the web material 3 according to invention the ligaments 8, applied at an angle and forming the inward-looking corners 7 are aligned in the tensile direction and press the orthogonally adjacent ligaments 9 outward, due to which a negative length variation of the pulled material perpendicular to the loading direction is avoided.

A web material 3 can be seen in FIG. 2a, wherein consolidated ligaments consisting of ligaments 8 and 9 are embodied in the web material 3 in such a way that they form the edges of isosceles triangles. The triangles are thereby arranged in such a way that they are interconnected in pairs and form inverted hexagons 6. Furthermore, the web material 3 comprises in second discrete regions 5 perforations, which lie inside these edges. Such an arrangement of perforations in a web material enables a load transmission along the consolidated ligaments 8 and 9, for example during tensile loading.

FIG. 2b illustrates the web material during the tensile loading, wherein the web material experiences an expansion in the x-direction. A neck-down effect transverse to the loading direction is not present, that is, the web material maintains the original web width during tensile loading.

In FIG. 3 an apparatus is illustrated for the production of a two-dimensional web material 3, said apparatus comprising a heatable embossing roller 10 with embossing patterns 11 and a smoothing roller 12 as a counter roller. The embossing patterns 11 of the embossing roller 10 protrude from the embossing roller as elevations in the form of ligaments 8, which form inverted hexagons and are in turn connected by orthogonally adjacent ligaments 9. The ligaments have an aspect ratio, that is, the ratio of their length to their width of between >2 and <20, preferably between 4 and 10 and are arranged at an angle of between >0° and <90° relative to one another.

The layers forming the layer material 3a to be compressed and/or consolidated and/or bound are provided separately in the form of a non-woven material 13 using a spinneret 14 with an extruder 14a and in the form of a film 15 and/or laminate 16 using unwinding devices 17 and deflecting rollers 18 and also guide rollers 19 and supplied to a roller clearance 20, which is formed by the smoothing roller 12 and the embossing roller 10. By interaction of the counter roller with the embossing roller, the web material in the roller clearance 20 in discrete regions is brought at a temperature exceeding its softening temperature and is compressed and/or consolidated and/or bound and subsequently supplied to a winding device 21. The compressed and/or consolidated and/or bound regions 8 and 9 are embodied on the web material 3 as stiff ligaments representing inverted hexagons 6.

FIG. 4 illustrates a comparison of the expansion of web materials known from prior art and expansion of the web material according to the invention. Here the occurred neck down effects in a conventional web material having standard bonding patterns are illustrated similar to FIG. 1a, a conventional web material having perforations and also a web material according to the invention having bonding patterns according to FIG. 1b and a web material according to the invention having perforations according to FIG. 2a.

While conventional web materials exhibit neck down values of between 2.5% and 5%, for example in case of a 2% expansion, neck down values of <1% are observed in the web material according to the invention and Poisson's ratios ν of between 0.18 and −1.83 are determined. Surprisingly, the web material according to the invention having perforations shows a length increase in the y direction in the order of magnitude of >2% in case of a 2% expansion.

1. Two-dimensional web material made of a layer material, wherein the two-dimensional web material contains a non-woven material and first and second discrete regions, which are arranged relative to one another in such a way that they form a pattern in the form of inverted polygons and that the two-dimensional layer material has a Poisson's ratio of <0.2 during expansion in the machine direction.

2. Two-dimensional web material made of a layer material according to claim 1, wherein the two-dimensional web material in the first discrete regions is compressed and/or consolidated and/or bound in such a way that the first discrete regions are embodied in the shape of ligaments forming the sides of the edges of inverted polygons and that the two-dimensional web material has a Poisson's ratio of <0.2 during expansion in the machine direction.

3. Two-dimensional web material according to claim 1, wherein the two-dimensional web material in the first discrete regions comprises ligaments forming the sides of the edges of inverted polygons and the sides have an aspect ratio of their length to their width of between >2 and <20, and are arranged at an angle of between >0° and <180° relative to one another and that the two-dimensional web material has a Poisson's ratio of <0.2 during expansion in the machine direction.

4. Two-dimensional web material according to claim 1, characterized in that it comprises second discrete regions, which are uncompressed and are embodied as inverted polygons and that the two-dimensional web material has a Poisson's ration of <0.2 during expansion in the machine direction.

5. Two-dimensional web material according to claim 1, characterized in that it comprises second discrete regions, which are perforated and are embodied as inverted polygons and that the two-dimensional web material has a Poisson's ratio of <0.2 during expansion in the machine direction.

6. Two-dimensional web material according to claim 1, characterized in that the polygons are inverted hexagons, which contain isosceles triangles.

7. Two-dimensional web material according to claim 1, characterized in that the polygons are inverted hexagons, which contain non-isosceles triangles.

8. Two-dimensional web material according to claim 1, wherein the two-dimensional web material in the first discrete regions comprises ligaments forming the sides of the edges of inverted hexagons and the sides have—an aspect ratio of their length to their width of between >2 and <20, and are arranged at an angle of between >0° and <90° relative to one another and that the two-dimensional web material has a Poisson's ratio of <0.2 during expansion in the machine direction.

9. Two-dimensional web material according to claim 1, characterized in that it comprises second discrete regions, which are uncompressed and are formed out of triangles, which are arranged in such a way relative to one another that they are interconnected in pairs in the region of their acute angles and form inverted hexagons and that the two-dimensional web material has a Poisson's ratio of <0.2 during expansion in the machine direction.

10. Two-dimensional web material according to claim 1, characterized in that it comprises in second discrete regions perforations, which are formed out of triangles, which are arranged in such a way relative to one another that they are interconnected in pairs in the region of their acute angles and form inverted hexagons and that the two-dimensional web material has a Poisson's ratio of <0.2 during expansion in the machine direction.

11. Method for manufacturing a two-dimensional web material out of a layer material, wherein the web material contains a non-woven material, and first and second discrete regions are arranged relative to one another in such a way that they form a pattern of the form of inverted polygons and that the two-dimensional layer material has a Poisson's ratio of <0.2 during expansion in the machine direction.

12. Method for manufacturing a two-dimensional web material out of a layer material according to claim 11, wherein first and second discrete regions are arranged in the two-dimensional web material relative to one another in such a way that they form a pattern in the form of inverted hexagons and that the two-dimensional layer material has a Poisson's ratio of <0.2 during expansion in the machine direction.

13. Method for manufacturing a two-dimensional web material out of a layer material according to claim 11, wherein the layer material is provided and it is compressed and/or consolidated and/or bound in first discrete regions and the first discrete regions are arranged relative to one another in such a way that they form a pattern in the form of inverted polygons.

14. Method for manufacturing a two-dimensional web material out of a layer material according to claim 11, wherein the layer material is provided and it is perforated in second discrete regions, which are arranged relative to one another in such a way that they form a pattern in the form of inverted polygons.

15. Method for manufacturing a two-dimensional web material according to claim 11, wherein the layer material is provided and a holt melt adhesive is applied on first discrete regions of the surface of the layer material in such a way that after the hardening of the hot melt adhesive in the first discrete regions a pattern in the form of ligaments forming the sides of the edges of inverted polygons is embodied.

16. Method for manufacturing a two-dimensional web material according to claim 11, wherein the first discrete regions are created by thermobonding.

17. Method for manufacturing a two-dimensional web material according to claim 11, wherein the first discrete regions are created by spunlacing.

18. Method for manufacturing a two-dimensional web material according to claim 11, wherein the first regions are created by airlacing.

19. Method for manufacturing a two-dimensional web material according to claim 11, wherein the first discrete regions are created by ultrasound processes.

20. Method for manufacturing a two-dimensional web material according to claim 11, wherein in the second discrete regions of the layer material embossing points are created by thermobonding.

21. Apparatus for manufacturing a two-dimensional web material out of a layer material, said apparatus comprising at least one embossing roller, wherein the embossing roller comprises oblong elevations in the form of ligaments, which are arranged relative to one another in such a way that they form the sides of the edges of inverted polygons such that the sides have—an aspect ratio of their length to their width of between >2 and <20, and a height of between 0.2 mm and 2 mm and are arranged at an angle of between >0° and <180° relative to one another.

22. Apparatus for manufacturing a two-dimensional web material out of a layer material according to claim 23, wherein the inverted polygons are embodied as inverted hexagons in such a way that the sides of the edges of the inverted hexagons have—an aspect ratio of their length to their width of between >2 and <20, and a height of between 0.2 mm and 2 mm and are arranged at an angle of between >0° and <90° relative to one another.

23. Apparatus for manufacturing a two-dimensional web material out of a layer material, said apparatus comprising a pivoted screening drum, wherein the screening drum comprises on its surface oblong openings, which are arranged in such a way relative to one another that they form the sides of the edge of the inverted polygons such that the sides have an aspect ratio of their length to their width of between >2 and <20, and are arranged at an angle of between >0° and <180° relative to one another.

24. Apparatus for manufacturing a two-dimensional web material out of a layer material, said apparatus comprising a device for the application of a hot melt adhesive, wherein the device comprises boreholes and/or nozzles, which are arranged relative to one another in such a way that they form the sides of the edges of inverted polygons such that the sides have an aspect ratio of their length to their width of between >2 and <20, and are arranged at an angle of between >0° and <180° relative to one another.

25. A sanitary product comprising the two-dimensional web material of claim 1.

26. A filter material comprising the two-dimensional web material of claim 1.

27. A packaging material comprising the two-dimensional web material of claim 1.

28. A geotextile comprising the two-dimensional web material of claim 1.
